(19) United States
(12) Patent Application Publication
(10) Pub. No.: US 2016/0031275 A1
(43) Pub. Date: Feb. 4, 2016

(54) VEHICLE FOR AERONAUTIC OPERATION AND SUBMERSED OPERATION

(71) Applicants: Paul MONROE, Cortland, OH (US); Devin WORK, Silver Spring, MD (US)

(72) Inventors: Paul MONROE, Cortland, OH (US); Devin WORK, Silver Spring, MD (US)

(21) Appl. No.: 14/449,963

(22) Filed: Aug. 1, 2014

(51) Int. Cl. B60F 3/00; B64C 39/02; B64C 27/32

(52) U.S. Cl. CPC B60F 3/0007; B64C 27/32; B64C 39/024; B60F 3/003; B64C 2201/024

(57) ABSTRACT

Vehicle for aeronautic operation and submersed operation includes members secured to rotors and a body, the members having adjustable features arranged and disposed to position the rotors to rotate in a first plane during the aeronautic operation and a second plane during the submersed operation, a fluid enclosure operably connected through the body to the rotor, the fluid enclosure having a submersion mechanism arranged and disposed for the vehicle to adjustably ascend and descend during the submersed operation of the vehicle, and a control system and power system for operably controlling the rotor, the adjustable feature, and/or the fluid enclosure. The rotor is configured to move the vehicle during the aeronautic operation and the submersed operation. A process includes operating the vehicle in the aeronautic operation and the submersed operation.

### FIELD OF THE INVENTION

The present invention is directed to vehicles and operation of vehicles. More particularly, the present invention is directed to vehicles for aeronautic operation and submersed operation.

### BACKGROUND OF THE INVENTION

Operation of aeronautic drones is well known. For example, aeronautic drones are becoming heavily used for surveillance purposes throughout the world. Some aeronautic drones operate based upon gliding principles, similar to planes and jets. Other aeronautic drones operate based upon rotation of blades, similar to helicopters. Many of these aeronautic drones are capable of landing in terrestrial environments. Some are even capable of landing on top of water, such as, sea planes. However, aeronautic drones are generally limited in their ability to be submersed in water, their ability to launch and re-launch from within water, and their ability to operate in water. For example, most aeronautic drones are rendered permanently inoperable by being submersed in water.

Submersed drones are also well known. Submersed drones are well known for use in exploratory and recovery efforts, such as, undersea biological pursuits and aviation and ship wreckage investigation. In general, submersed drones encounter issues very different from aeronautic drones. While weight is generally undesirable on aeronautic drones, submersed drones can benefit from weight to permit further submersion within water. Submersed drones also require containment of electrical systems to prevent water from rendering the drones inoperable.

In the past, the different challenges between aeronautic drones and submersed drones have resulted in separate drones being used for separate operations. Some devices have had limited operation in both environments, such as, submarine-launched missiles. However, such devices have not been capable of repeatedly launching and re-launching from submersed operation into aeronautic operation. In addition, such devices operate by using different stages or systems for operation in each environment.

A vehicle for aeronautic operation and submersed operation and a method of operating a vehicle in aeronautic operation and submersed operation that show one or more improvements in comparison to the prior art would be desirable in the art.

### BRIEF DESCRIPTION OF THE INVENTION

In an embodiment, a vehicle for aeronautic operation and submersed operation includes members secured to rotors and a body, the members having adjustable features arranged and disposed to position the rotors to rotate in at least a first plane during the aeronautic operation and a second plane during the submersed operation, the first plane being at least 30 degrees from the second plane relative to the body, a fluid enclosure operably connected through the body to the rotor, the fluid enclosure having a submersion mechanism arranged and disposed for the vehicle to adjustably ascend and descend during the submersed operation of the vehicle, and a control system and power system for operably controlling one or more of the rotor, the adjustable feature, and the fluid enclosure. The rotor is configured to move the vehicle during the aeronautic operation and the submersed operation.

In another embodiment, a vehicle for aeronautic operation includes a rotor arranged and disposed for the aeronautic operation, a fluid enclosure operably connected to the rotor through a body, the fluid enclosure having a fluid drawing mechanism arranged and disposed for the vehicle to draw a fluid into the fluid enclosure, and a control system and power system for operably controlling the rotor and the fluid drawing mechanism.

In another embodiment, a process of aeronautic operation and submersed operation of a vehicle includes providing a vehicle, the vehicle having rotors connected to a member having an adjustable feature, the adjustable feature being arranged and disposed to position the rotors, operating the vehicle in the aeronautic operation with the rotors positioned in a first plane, adjusting the rotors to a second plane for the submersed operation, the first plane being at least 30 degrees from the second plane, and operating the vehicle in submersed operation with the rotors in the second plane.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of a vehicle for aeronautic operation and submersed operation positioned in an aeronautic operation mode, according to an embodiment of the disclosure.

FIG. 2 is a perspective view of a vehicle for aeronautic operation and submersed operation positioned in a submersed operation mode, according to an embodiment of the disclosure.

FIG. 3 is a schematic section view of a fluid enclosure, specifically a submersion mechanism, in a buoyant position as part of a vehicle for aeronautic operation and submersed operation, according to an embodiment of the disclosure.

FIG. 4 is a schematic section view of a fluid enclosure, specifically a submersion mechanism, in a submersed position as part of a vehicle for aeronautic operation and submersed operation, according to an embodiment of the disclosure.

FIG. 5 is a schematic section view of a fluid enclosure, specifically a fluid drawing mechanism, in a discharge position as part of a vehicle for aeronautic operation and submersed operation, according to an embodiment of the disclosure.

FIG. 6 is a schematic section view of a fluid enclosure, specifically a fluid drawing mechanism, in a recovery position as part of a vehicle for aeronautic operation and submersed operation, according to an embodiment of the disclosure.

Wherever possible, the same reference numbers will be used throughout the drawings to represent the same parts.

### DETAILED DESCRIPTION OF THE INVENTION

Provided is a vehicle for aeronautic operation and submersed operation and a process of aeronautic operation and submersed operation. Embodiments of the present disclosure, for example, in comparison to concepts failing to include one or more of the features disclosed herein, are capable of use for surveillance purposes, are capable of operation based upon rotation of blades (similar to helicopters), are capable of landing in terrestrial environments, are capable of landing on top of liquid (such as, water), are capable of being submersed in water, are capable of launching and re-launching from within water, are capable of operating in water (for example, while submersed and/or on water as a fan-boat-type operation), includes electrical or other operational systems that are fully enclosed/contained, includes a single system for aeronautic and submersed operation, other suitable features that will be apparent from features disclosed herein, or combinations thereof.

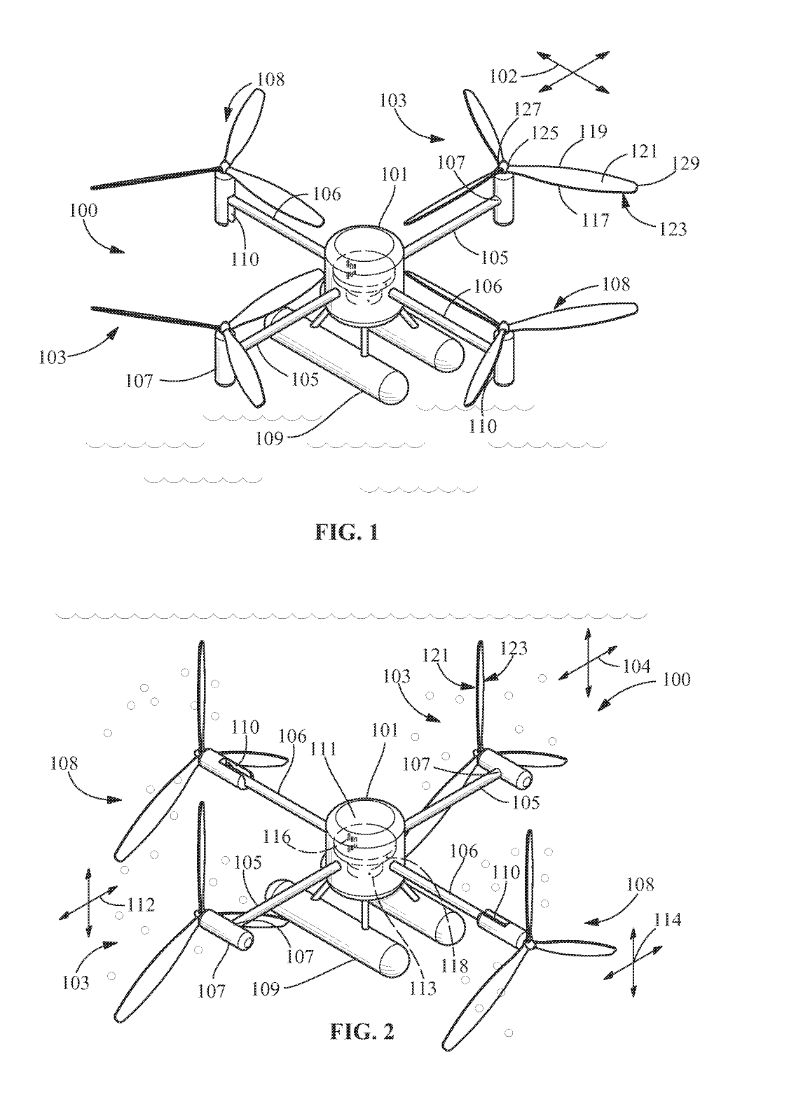

FIGS. 1-2 show an embodiment of a vehicle 100 capable of aeronautic operation (FIG. 1) and submersed operation (FIG. 2), for example, a remote-operated vehicle or drone. The vehicle 100 includes a body 101 having any suitable number of rotors 103 extending along members 105 from the body 101. Suitable numbers of the rotors include, but are not limited to, two of the rotors 103, three of the rotors 103, four of the rotors 103, or more than four of the rotors 103.

At least one of the rotors 103 and/or the members 105 has an adjustable feature 107 arranged and disposed to adjustably position the rotor 103 in a first plane 102 during aeronautic operation (FIG. 1) and a second plane 104 during submersed operation (FIG. 2) or, according to one embodiment, at any position between the first plane 102 and the second plane 104 during either operational mode. In one embodiment, the vehicle 100 has more than one of the rotors 103 having the adjustable features 107, for example, two of the rotors 103, three of the rotors 103, four of the rotors 103, more than four of the rotors 103, and/or all of the rotors 103. In one embodiment, the vehicle 100 further includes additional rotors 108 and corresponding additional adjustable features 110 on none, any, or all of the additional rotors 108.

To adjust from the aeronautic operation (FIG. 1) to the submersed operation (FIG. 2), the first plane 102 is at least 30 degrees from the second plane 104. In one embodiment, the first plane 102 differs from the second plane 104 by at least 45 degrees, at least 60 degrees, at least 90 degrees, between 30 degrees and 90 degrees, between 45 degrees and 90 degrees, between 45 degrees and 60 degrees, between 60 degrees and 90 degrees, between 30 degrees and 120 degrees, between 45 degrees and 120 degrees, between 60 degrees and 120 degrees, between 90 degrees and 120 degrees, between 30 degrees and 180 degrees, between 45 degrees and 180 degrees, between 60 degrees and 180 degrees, between 90 degrees and 180 degrees, or any suitable combination, sub-combination, range, or sub-range therein.

Adjustment from the first plane 102 to the second plane 104 and/or from the second plane 104 to the first plane 102 is achievable due to the adjustable features 107 and/or the additional adjustable features 110. The adjustable features 107 and/or the additional adjustable features 110 are any suitable arrangements and/or mechanisms capable of modifying the orientation of the rotors 103 and/or the additional rotors 108, such as, being laterally-adjustable, axially-adjustable, and/or rotationally-adjustable. In one embodiment, the adjustable features 107 are rotationally-adjustable about the members 105 and the additional adjustable features 110 are capable of pivoting along the additional members 106, for example, by being slotted.

In one embodiment, the adjustable features 107 and/or the additional adjustable features 110 include a ball-and-socket, a swivel, a bearing, an electrical rotary union, an air rotary union, a hydraulic coupling, a lever, a pivot mechanism, a hinge, a telescoping member, any other coupling or joint capable of rotating, pivoting, extending, or retracting, or a combination thereof. For example, in a further embodiment, the adjustable features 107 include ball-and-socket joints that provide rotation in a plurality of axes centered on the members 105 and/or unlimited degrees of movement, while the additional adjustable features 110 include pivot joints that provide rotation about an axis perpendicular to the additional members 106. In another embodiment, the adjustable features 107 and/or the additional adjustable features 110 are coupled to the members 105 and/or the additional members 106, respectively, through telescoping members that provide lateral adjustability.

The adjustable feature 107 and/or additional adjustable features 110 is/are controlled and powered by a control system 111 and a power system 113. In one embodiment, the adjustable feature 107 and/or additional adjustable features 110 include(s) an actuating mechanism that adjusts in response to power from the power system 113, a signal from the control system 111, compressed air from an air compressor operably connected to the control system 111, another mechanism operably connected to the control system 111, or a combination thereof. In one embodiment, the actuating mechanism includes a linear motor, such as a servo motor. In another embodiment, the actuating mechanism includes one or more linear motors to provide adjustability in a plurality of axes.

In one embodiment, the members 105 consist of two of the members 105 and the rotors 103 consist of two of the rotors 103 and two additional members 106 extend from the body 101 to two of the additional rotors 108, the two additional members 106 having two of the additional adjustable features 110 arranged and disposed to position the additional rotors 108 in the first plane 102 during the aeronautic operation (FIG. 1) and a first parallel plane 112 and second parallel plane 114, parallel to each other and to the second plane 104, during the submersed operation (FIG. 2). In other embodiments, the two additional members 106 and/or the members 105 are relatively adjusted to provide operational maneuverability, for example, during the aeronautic operation (FIG. 1) and/or the submersed operation (FIG. 2). As will be appreciated, any suitable number of the members 105, the rotors 103, the additional members 106, and the additional rotors 108 are capable of being included in the vehicle 100.

The body 101, the rotors 103, the additional rotors 108, the members 105, and/or the additional members 106 are composed of the same materials or different materials, such as, polymeric materials, composite materials, metal materials, metallic materials, any other suitable material capable of use in water and air, or a combination thereof. The materials are capable of being formed by any suitable technique, such as, additive techniques (for example, selective laser sintering, also known as, three-dimensional printing), machining techniques, and/or molding techniques.

The rotors 103 and/or the additional rotors 108 are secured to the members 105 and/or the additional members 106, which are secured to the body 101 by any suitable technique. Suitable techniques include, but are not limited, to, ultrasonic welding, utilizing fasteners, and utilizing adhesives. In one embodiment, the body 101 and the members 105 and/or the additional members 106 are formed together, for example, by injection molding and/or additive techniques. In other embodiments, the body 101 and the members 105 and/or the additional members 106 are formed separately, segmented (for example, having interchangeable portions and/or having telescoping portions for accommodating different sizes or other parameters).

The members 105 and/or the additional members 106 include functionality and features permitting the rotors 103 and/or the additional rotors 108 to be operated by the control system 111 (for example, having internal controls and/or having communications interfaces 116) and the power system 113, for example, positioned and sealed within the body 101. In one embodiment, the members 105 and/or the additional members 106 include slots or channels extending from the body 101 to the rotors 103 and/or the additional rotors 108 for wires and/or cables. In another embodiment, the members 105 and/or the additional members 106 are hollow, thereby permitting the wires and/or the cables to be positioned, enclosed, sealed, and/or contained within the members 105 and/or the additional members 106. In one embodiment, the communication interfaces 116 are capable of interfacing with a remote system by radiofrequency signals, infrared signals, acoustic signals, visible signals, or a combination thereof. In further embodiments, one or more information gathering devices 118 or a portion of such are included, for example, a still image camera, a video camera, an infrared detector, a spectrometer, an accelerometer, a thermometer, a water/liquid sample tool, a depth gauge, an altimeter, a global positioning device, a range finder (such as a sonic or laser range finder), or a combination thereof.

In an embodiment with the information being transmitted, the information is transmitted in discrete compressed bundles and/or in binary format, for example, at least when operating in the submersed operation. The body 101 is capable of containing other suitable features, such as, an air compressor, a nozzle/sprayer, a parachute, an emergency floatation device, a transponder, lights, speakers, lasers, mechanical arms, or a combination thereof.

The rotors 103 and/or the additional rotors 108 include any suitable mechanisms for aeronautic operation and submersible operation. For example, as shown in FIG. 1, the rotors 103 and/or the additional rotors 108 are capable of including one or more blades 115 having a leading edge 117, a trailing edge 119, a suction side 121, and a pressure side 123 for increased operational efficiency. Similarly, the blades 115 are capable of including an interface 125, such as, a dovetail, connected to a wheel 127 or nacelle opposite a tip 129 on the blade 115 and/or any other suitable features or components for operation of a turbine. As shown in FIG. 1, in the aeronautic operation, the suction side 121 and the pressure side 123 of each of the blades 115 are oriented in one direction, for example, downward or partially downward, to provide elevation. As used herein, directional terms correspond to the direction of gravity being downward or substantially downward.

As shown in FIG. 2, in the submersed operation, the suction side 121 and the pressure side 123 of each of the blades 115 are oriented in one direction to provide a horizontal, or at least partially horizontal, thrust. In response to signals and/or operational commands from the control system 111, the rotors 103 are capable of independently or collectively reversing direction, increasing/decreasing velocity, increasing/decreasing torque, increasing/decreasing relative outputs of the rotors 103, or a combination thereof.

The vehicle 100 includes one or more fluid enclosures 109 (for example, pontoons) operably connected to the body 101, for example, by extending below the body 101 of the vehicle 100. The fluid enclosures 109 are capable of providing buoyancy, balancing the vehicle 100 in water and/or air, providing a platform for landing, facilitating recovery of fluid, or any other suitable functions and/or properties for the aeronautic operation and/or the submersed operation. The fluid enclosure(s) 109 is/are capable of being used in numerous applications, such as, firefighting (for example, by including a fire retardant, such as, a compressed fire retardant), military operations (for example, deploying chemical weapons, deploying explosives, discharging munitions/projectiles, or a combination thereof), agricultural applications (for example, fluid and/or herbicide dispersion), industrial applications, chemical reactions (for example, by including reactive substances in the fluid enclosure 109), or a combination thereof. The fluid enclosures 109 are capable of including internal mechanisms for such applications or are capable of being removed and/or replaced, for example, upon manual or automatic decoupling and/or deployment. In one embodiment, the vehicle 100 is configured for multiple size, weights, and shapes of the fluid enclosures 109 to be secured to the vehicle 100 to achieve desired applications.

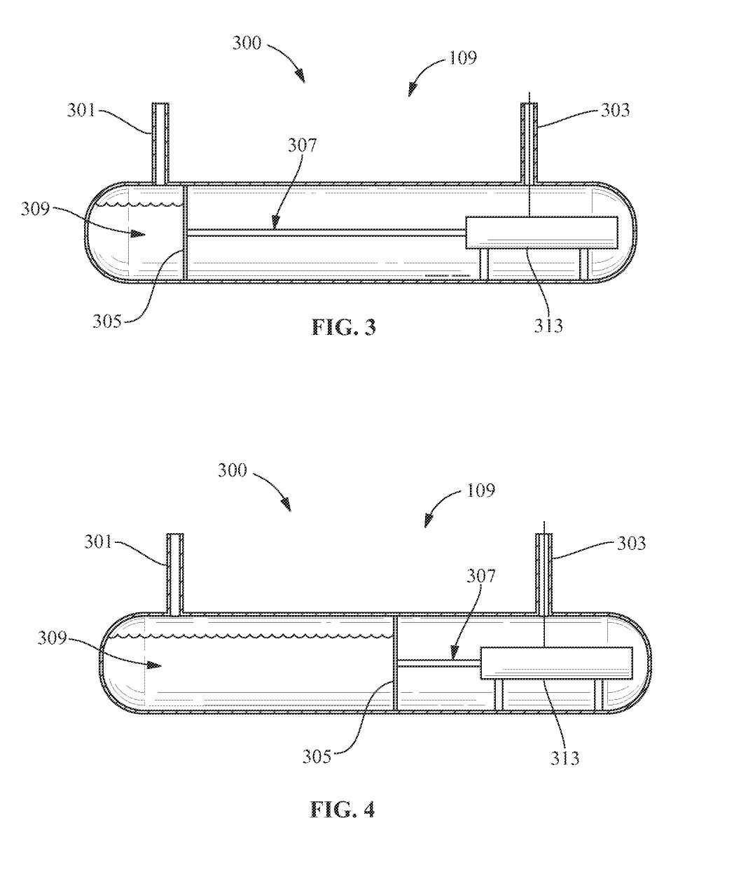

Referring to FIGS. 3-6, in one embodiment, the fluid enclosures 109 include a compressible region 309 with a fluid conduit 301 extending to the body 101 and/or out of the vehicle 100. In one embodiment, the fluid conduit 301 and/or the conduit 303 provide(s) or allow(s) the release of compressed air, for example, capable of being compressed from the air compressor. The compressible region 309 is partially defined by a plunger 305 that is adjustable based upon an extension mechanism 307, such as, a spring, a slide, and/or a coil, being extended or retracted in response to an operational mechanism 313 connected to the control system 111 and/or the power system 113, for example, through the conduit 303 to the body 101.

In one embodiment, the fluid enclosure 109 is a submersion mechanism 300 (see FIGS. 3-4), such as, a ballast, with a buoyant position (see FIG. 3) and submersed/non-buoyant position (see FIG. 4). The vehicle 100 is capable of floating on, being partially submerged within, or rising within a liquid, such as, water, while the fluid enclosure 109 is in the buoyant position. The vehicle 100 is capable of being partially submerged within, completely submerged within, or lowering within the liquid while the fluid enclosure 109 is in the submersed position. Adjustment of the fluid enclosure 109 permits the vehicle 100 to adjustably ascend and descend during the submersed operation of the vehicle 100.

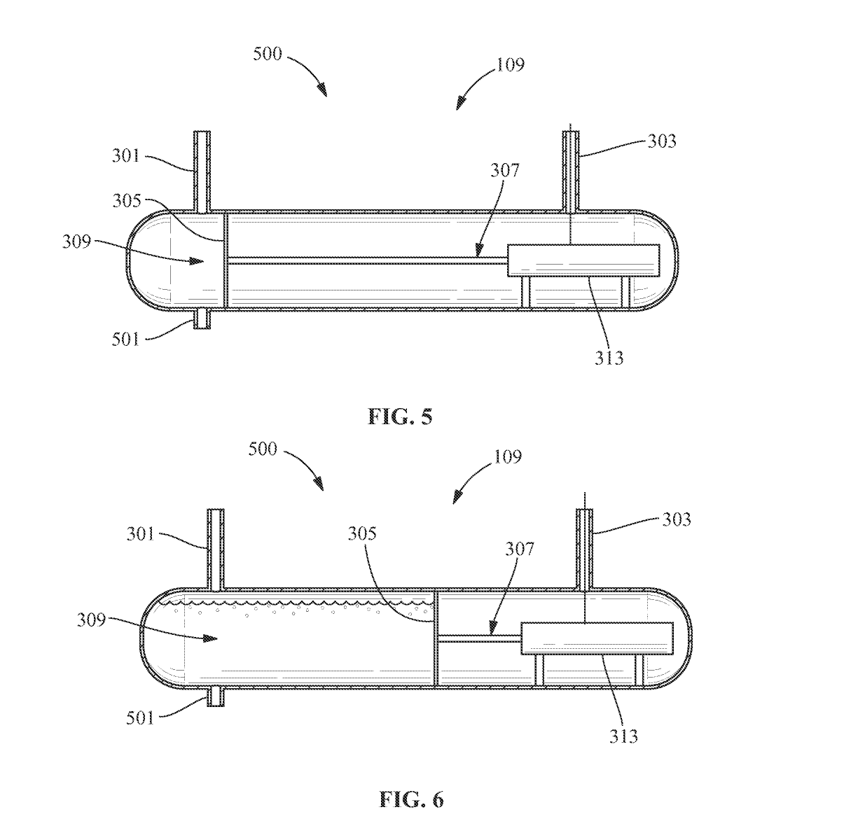

In one embodiment, the fluid enclosure 109 is a fluid-drawing mechanism 500 (FIGS. 5-6), with a discharge configuration (FIG. 5) and a recovery configuration (FIG. 6). The vehicle 100 is capable of collecting any suitable fluid, for example, a gas for air quality monitoring (such as, NOₓ and/or SOₓ detection/monitoring, particulate/pollutant detection, or a combination thereof), and/or a liquid for water quality monitoring (such as, discharge pools, hazardous materials, superfund sites, nuclear contaminated liquids, cooling ponds, or a combination thereof).

The vehicle 100 collects the fluid by adjusting from the discharge configuration (FIG. 5) to the recovery configuration (FIG. 6), thereby drawing the fluid through a collection feature 501 into the fluid enclosure 109, such as, a one-way valve, a sealed orifice, an opening closed by the movement from the discharge configuration (FIG. 5) to the recovery configuration (FIG. 6), or a combination thereof. The fluid is either released by a reverse process of adjusting from the recovery configuration (FIG. 6) to the discharge configuration (FIG. 5) or by other extraction techniques.

Operation of the vehicle 100 permits a greater number of degrees of movement than prior drones failing to include the features disclosed herein. Such degrees of movement are capable of being based upon four or more points of control, eight or more points of control, twelve or more points of control, fourteen or more points of control, or any suitable combination, sub-combination, range, or sub-range therein. For example, points of control include adjusting the direction of rotation for one or more of the rotors 103 and/or the additional rotors 108 from clock-wise to counter-clock-wise, adjusting the relative position of one or more of the rotors 103 and/or the additional rotors 108 from the first plane 102 to the second plane 104 or between the first plane 102 and the second plane 104, adjusting the tilt or angle of one or more of the blades 115, adjusting the buoyancy of one or more of the fluid enclosures 109, adjusting the speed of one or more of the rotors 103, or a combination thereof.

The vehicle 100 includes any suitable characteristics permitting desired operation. Suitable characteristics, for example, include having weight above or below 1 kg, 10 kg, 50 kg, 100 kg, 1,000 kg, 5,000 kg, 10,000 kg, or any suitable combination, sub-combination, range, or sub-range therein. Additionally or alternatively, suitable characteristics include, but are not limited to, having an overall profile area that is greater than or less than, 10 cm², 50 cm², 100 cm², 1,000 cm², 10 m², 20 m², 30 m², or any suitable combination, sub-combination, range, or sub-range therein. In one embodiment, the characteristics include having a maximum dimension (the greatest length within the vehicle 100) that is greater than or less than, 5 cm, 10 cm, 50 cm, 100 cm, 1,000 cm, 10,000 cm, or any suitable combination, sub-combination, range, or sub-range therein.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A vehicle for aeronautic operation and submersed operation, the vehicle comprising:
members secured to rotors and a body, the members having adjustable features arranged and disposed to position the rotors to rotate relative to the body in at least a first plane during the aeronautic operation and a second plane during the submersed operation, the first plane being at least 30 degrees from the second plane;
a fluid enclosure operably connected through the body to the rotor, the fluid enclosure having a submersion mechanism arranged and disposed for the vehicle to adjustably ascend and descend during the submersed operation of the vehicle; and
a control system and power system for operably controlling one or more of the rotors, the adjustable features, and the fluid enclosure;
wherein the rotor is configured to move the vehicle during the aeronautic operation and the submersed operation.

2. The vehicle of claim 1, wherein the first plane is at least 90 degrees from the second plane relative to the body.

3. The vehicle of claim 1, wherein the vehicle is arranged and disposed for the rotors to be positioned throughout adjustment from being in the first plane to being in the second plane, the first plane being 180 degrees from the second plane.

4. The vehicle of claim 1, wherein the vehicle includes at least 8 degrees of movement for the rotors.

5. The vehicle of claim 1, wherein the vehicle is capable of launching from at least partially within a liquid in the submersed operation to be positioned completely above the liquid in the aeronautic operation.

6. The vehicle of claim 1, wherein the vehicle is capable of landing on a solid surface and launching to operate in air during the aeronautic operation.

7. The vehicle of claim 1, wherein the vehicle is capable of landing on a liquid and launching to operate in air during the aeronautic operation.

8. The vehicle of claim 1, wherein the vehicle is capable of submerging in a liquid and launching from the liquid to operate in air during the aeronautic operation.

9. The vehicle of claim 1, wherein the vehicle is capable of repeatedly submerging in a liquid after operating in air during the aeronautic operation, is capable of repeatedly submerging in the liquid without previously operating in the air during the aeronautic operation, is capable of repeatedly launching from in the liquid to operate in the air during the aeronautic operation, is capable of repeatedly launching from a solid surface to operate in air during the aeronautic operation, is capable of repeatedly launching from on the liquid to operate in the air during the aeronautic operation, is capable of repeatedly landing on the liquid, is capable of repeatedly landing in the liquid, and is capable of repeatedly landing on the solid surface.

10. The vehicle of claim 1, wherein the power system includes a battery or an internal combustion engine.

11. The vehicle of claim 1, wherein the vehicle is unmanned.

12. The vehicle of claim 1, wherein the vehicle is remote-operated.

13. The vehicle of claim 1, wherein the vehicle is autonomously-operated.

14. The vehicle of claim 1, wherein the fluid enclosure further includes a fluid drawing mechanism.

15. The vehicle of claim 1, wherein the vehicle is configured to gather information.

16. The vehicle of claim 1, wherein the vehicle is configured to gather fluid samples.

17. The vehicle of claim 1, wherein the members consist of two members and the rotors consist of two rotors and two additional members extend from the body to two additional rotors, the two additional members having two additional adjustable features arranged and disposed to position the additional rotors in the first plane during the aeronautic operation and two parallel planes, parallel to each other and to the second plane.

18. A process of operating the vehicle of claim 1 in the aeronautic operation, then submersed operation, then the aeronautic operation.

19. A vehicle for aeronautic operation, the vehicle comprising:
a rotor arranged and disposed for the aeronautic operation;
a fluid enclosure operably connected to the rotor through a body, the fluid enclosure having a fluid drawing mechanism arranged and disposed for the vehicle to draw a fluid into the fluid enclosure;
a control system and power system for operably controlling the rotor and the fluid drawing mechanism.

20. A process of aeronautic operation and submersed operation of a vehicle, the process comprising:
providing a vehicle, the vehicle having rotors connected to a member having adjustable features, the adjustable features being arranged and disposed to position the rotors;
operating the vehicle in the aeronautic operation with the rotors positioned in a first plane;
adjusting the rotors to a second plane for the submersed operation, the first plane being at least 30 degrees from the second plane; and
operating the vehicle in the submersed operation with the rotors in the second plane.
